(19) United States
(12) Patent Application Publication
(10) Pub. No.: US 2025/0126347 A1
(43) Pub. Date: Apr. 17, 2025

(54) MOBILE TERMINAL, PROGRAM, AND METHOD OF PROCESSING CHARACTERISTIC DATA OF HYDRAULIC PUMP

(71) Applicant: KAWASAKI JUKOGYO KABUSHIKI KAISHA, Kobe-shi, Hyogo (JP)

(72) Inventors: Akihiro KONDO, Kobe-shi (JP); Jun UMEKAWA, Kobe-shi (JP); Hiroyasu KODERA, Kobe-shi (JP); Yousuke KATAOKA, Kobe-shi (JP)

(73) Assignee: KAWASAKI JUKOGYO KABUSHIKI KAISHA, Kobe-shi, Hyogo (JP)

(21) Appl. No.: 18/729,279

(22) PCT Filed: Jan. 24, 2023
(86) PCT No.: PCT/JP2023/001994

§ 371 Date: Jul. 16, 2024

(30) Foreign Application Priority Data
Mar. 28, 2022 (JP) 2022-051112

(51) Int. Cl. H04N 23/61; G06F 3/04817; H04N 23/63; H04N 23/661

(52) U.S. Cl. CPC H04N 23/61; G06F 3/04817; H04N 23/631; H04N 23/661

(57) ABSTRACT

A processor of a mobile terminal according to one embodiment, when a camera has captured an image of a code that is displayed on a surface of hydraulic pump equipment and that stores characteristic data of at least one pump included in the hydraulic pump equipment, stores the characteristic data in a memory. Further, the processor displays a virtual characteristic data transmission button on a touchscreen, and when the characteristic data transmission button is tap-operated, causes a wireless communicator to transmit the characteristic data stored in the memory to control circuitry for the hydraulic pump equipment or to a wireless LAN router connected to the control circuitry.

### TECHNICAL FIELD

The present disclosure relates to a mobile terminal that is communicable with control circuitry for hydraulic pump equipment via wireless communication, a program for the mobile terminal, and a method of processing characteristic data of a hydraulic pump.

### BACKGROUND ART

In machines such as construction machines or industrial machines, there is a case where hydraulic pump equipment including at least one pump whose displacement, i.e., a delivery amount per rotation, increases in accordance with increase in a pump command current is adopted as hydraulic pump equipment to supply hydraulic oil to a hydraulic actuator (see Patent Literature 1, for example). In this case, the hydraulic pump equipment is controlled by control circuitry, such that the displacement of the pump increases in accordance with increase in the moving speed of the hydraulic actuator.

Specifically, the control circuitry receives an input of an actuator operation signal corresponding to an operating amount of an operator. The operator is a device to move the hydraulic actuator, and the operating amount of the operator determines the moving speed of the hydraulic actuator. The control circuitry outputs a pump command current corresponding to the actuator operation signal to the hydraulic pump equipment.

### CITATION LIST

### Patent Literature

PTL 1: Japanese Laid-Open Patent Application Publication No. 2019-210974

### SUMMARY OF INVENTION

### Technical Problem

Incidentally, each pump in the hydraulic pump equipment varies in terms of I-q characteristics due to their individual differences. The I-q characteristics are a relationship between the pump command current and the displacement of the pump. Patent Literature 1describes the following: a code that stores characteristic data indicating actual I-q characteristics of the pump (although Patent Literature 1 describes “a relationship between the command current and delivery flow rate”, the displacement can be obtained by dividing the delivery flow rate by the number of rotations) is displayed on the surface of the hydraulic pump equipment, and by use of a code reader, the characteristic data is inputted to the control circuitry for the hydraulic pump equipment, and the variation in the I-q characteristics due to the individual differences is electronically calibrated by the control circuitry. Specifically, the control circuitry adjusts the pump command current outputted to the hydraulic pump equipment, such that a preset displacement corresponding to the operating amount of the operator is obtained.

In this respect, there is a desire to perform the input of the characteristic data to the control circuitry not by using a code reader, but by using a mobile terminal.

In view of the above, an object of the present disclosure is to make it possible to input the characteristic data of the pump from a mobile terminal to the control circuitry.

### Solution to Problem

A first aspect of the present disclosure provides a mobile terminal including a processor, a memory, a wireless communicator, a touchscreen, and a camera. The processor: when the camera has captured an image of at least one code that is displayed on a surface of hydraulic pump equipment and that stores characteristic data of at least one pump included in the hydraulic pump equipment, stores the characteristic data in the memory; displays, on the touchscreen, a virtual characteristic data transmission button to receive an input to transmit the characteristic data to control circuitry for the hydraulic pump equipment or to a wireless LAN router connected to the control circuitry, and causes the wireless communicator to transmit the characteristic data stored in the memory to the control circuitry or to the wireless LAN router when the characteristic data transmission button is tap-operated.

A second aspect of the present disclosure provides a mobile terminal including a processor, a memory, a wireless communicator, a touchscreen, and a camera. The processor: when the camera has captured an image of at least one code displayed on a surface of hydraulic pump equipment, obtains characteristic data of at least one pump included in the hydraulic pump equipment via a network from a server specified by save location information stored in the at least one code, and stores the characteristic data in the memory; displays, on the touchscreen, a virtual characteristic data transmission button to receive an input to transmit the characteristic data to control circuitry for the hydraulic pump equipment or to a wireless LAN router connected to the control circuitry; and causes the wireless communicator to transmit the characteristic data stored in the memory to the control circuitry or to the wireless LAN router when the characteristic data transmission button is tap-operated.

A third aspect of the present disclosure provides a program for a mobile terminal, the mobile terminal including a processor, a memory, a wireless communicator, a touchscreen, and a camera. The program causes the processor to: when the camera has captured an image of at least one code that is displayed on a surface of hydraulic pump equipment and that stores characteristic data of at least one pump included in the hydraulic pump equipment, store the characteristic data in the memory; display, on the touchscreen, a virtual characteristic data transmission button to receive an input to transmit the characteristic data to control circuitry for the hydraulic pump equipment or to a wireless LAN router connected to the control circuitry; and cause the wireless communicator to transmit the characteristic data stored in the memory to the control circuitry or to the wireless LAN router when the characteristic data transmission button is tap-operated.

A fourth aspect of the present disclosure provides a program for a mobile terminal, the mobile terminal including a processor, a memory, a wireless communicator, a touchscreen, and a camera. The program causes the processor to: when the camera has captured an image of at least one code displayed on a surface of hydraulic pump equipment, obtain characteristic data of at least one pump included in the hydraulic pump equipment via a network from a server specified by save location information stored in the at least one code, and store the characteristic data in the memory; display, on the touchscreen, a virtual characteristic data transmission button to receive an input to transmit the characteristic data to control circuitry for the hydraulic pump equipment or to a wireless LAN router connected to the control circuitry; and cause the wireless communicator to transmit the characteristic data stored in the memory to the control circuitry or to the wireless LAN router when the characteristic data transmission button is tap-operated.

A fifth aspect of the present disclosure provides a method of processing characteristic data of a hydraulic pump by using a mobile terminal, the method including: when a camera of the mobile terminal has captured an image of at least one code that is displayed on a surface of hydraulic pump equipment and that stores characteristic data of at least one pump included in the hydraulic pump equipment, storing the characteristic data in a memory of the mobile terminal; displaying, on a touchscreen of the mobile terminal, a virtual characteristic data transmission button to receive an input to transmit the characteristic data to control circuitry for the hydraulic pump equipment or to a wireless LAN router connected to the control circuitry; and causing a wireless communicator of the mobile terminal to transmit the characteristic data stored in the memory to the control circuitry or to the wireless LAN router when the characteristic data transmission button is tap-operated.

A sixth aspect of the present disclosure provides a method of processing characteristic data of a hydraulic pump by using a mobile terminal, the method including: when a camera of the mobile terminal has captured an image of at least one code displayed on a surface of hydraulic pump equipment, obtaining characteristic data of at least one pump included in the hydraulic pump equipment via a network from a server specified by save location information stored in the at least one code, and storing the characteristic data in a memory of the mobile terminal; displaying, on a touchscreen of the mobile terminal, a virtual characteristic data transmission button to receive an input to transmit the characteristic data to control circuitry for the hydraulic pump equipment or to a wireless LAN router connected to the control circuitry; and causing a wireless communicator of the mobile terminal to transmit the characteristic data stored in the memory to the control circuitry or to the wireless LAN router when the characteristic data transmission button is tap-operated.

### Advantageous Effects of Invention

The present disclosure makes it possible to input the characteristic data of the pump from the mobile terminal to the control circuitry.

### BRIEF DESCRIPTION OF DRAWINGS

FIG. 1 shows a schematic configuration of a calibration system including a mobile terminal according to one embodiment.

FIG. 2 shows a schematic configuration of hydraulic pump equipment.

FIG. 3 shows a display screen on a touchscreen before both a first code and a second code are read.

FIG. 4 shows a display screen on the touchscreen after the first code has been read.

FIG. 5 shows a display screen on the touchscreen after an image of the first code has been captured two times consecutively.

FIG. 6 shows a display screen on the touchscreen in a case where the hydraulic pump equipment is of a parallel type.

FIG. 7 shows a schematic configuration of the calibration system including a variation of the mobile terminal.

### DESCRIPTION OF EMBODIMENTS

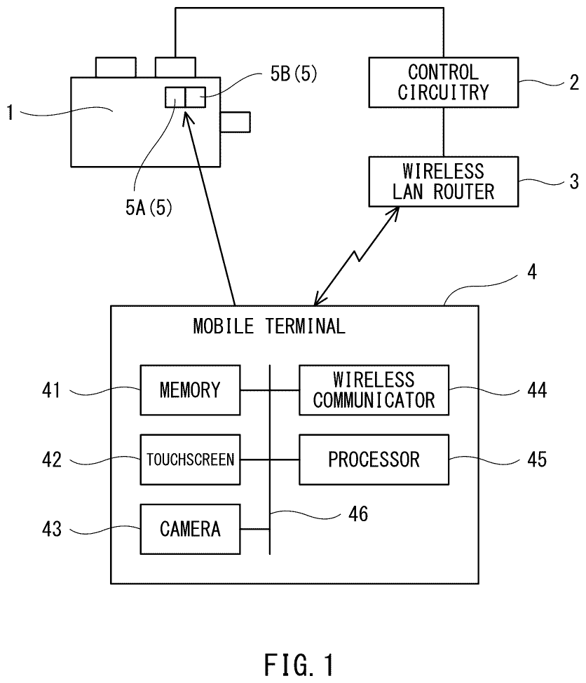

FIG. 1 shows a calibration system including a mobile terminal 4 according to one embodiment. A program is installed on the mobile terminal 4.

The calibration system includes, in addition to the mobile terminal 4, hydraulic pump equipment 1 and control circuitry 2 for the hydraulic pump equipment 1. The mobile terminal 4 is communicable with the control circuitry 2 via wireless communication.

In the present embodiment, a wireless LAN router 3 is wire-connected to the control circuitry 2, and the mobile terminal 4 performs wireless communication with the wireless LAN router 3. Alternatively, the control circuitry 2 may include a wireless communicator, and the mobile terminal 4 may directly perform wireless communication with the control circuitry 2.

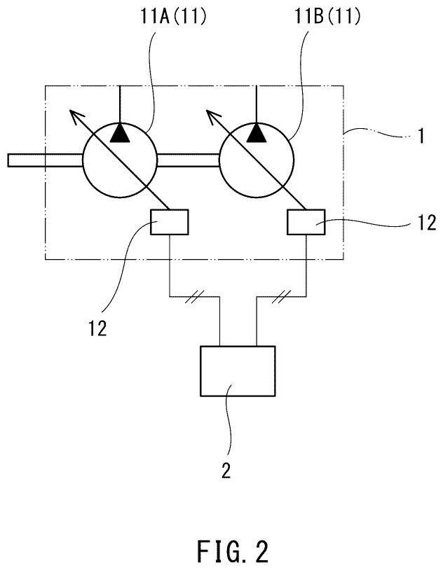

As shown in FIG. 2, the hydraulic pump equipment 1 includes: at least one pump 11 of a variable displacement type; and at least one regulator 12, which changes the displacement of the corresponding pump 11. In the present embodiment, the hydraulic pump equipment 1 includes two pumps 11 (a first pump 11A and a second pump 11B) and two regulators 12. Alternatively, the number of pumps 11 included in the hydraulic pump equipment 1 may be one.

In the present embodiment, each pump 11 is a swash plate pump (axial piston pump). Further, in the present embodiment, the hydraulic pump equipment 1 is of a tandem type, in which the center axes of the respective two pumps 11 are coaxial with each other. Alternatively, the hydraulic pump equipment 1 may be of a parallel type, in which the center axes of the respective two pumps 11 are parallel to each other. Further alternatively, the hydraulic pump equipment 1 may include one or two bent axis pumps as the pump(s) 11.

The hydraulic pump equipment 1 is driven by a prime mover (an engine or an electric motor). Both in the case where the hydraulic pump equipment 1 is of a tandem type and in the case where it is of a parallel type, the hydraulic pump equipment 1 includes one input shaft, and the input shaft is coupled to the output shaft of the prime mover.

Each regulator 12 receives an input of a pump command current I from the control circuitry 2. A displacement q of each pump 11, which is a delivery amount per rotation of the pump 11, increases in accordance with increase in the pump command current I inputted to the corresponding regulator 22.

For example, the regulator 12 may change hydraulic pressure applied to a servo piston coupled to the swash plate of the pump 11 in accordance with the pump command current I. In this case, in accordance with increase in the pump command current I, the servo piston shifts in such a direction as to increase the tilting angle of the swash plate. Alternatively, the regulator 12 may be an electric actuator coupled to the swash plate.

Each pump 11 supplies hydraulic oil to a hydraulic actuator. The number of hydraulic actuators may be one, or may be plural. The control circuitry 2 receives an input of an actuator operation signal corresponding to an operating amount of an operator that is a device to move the hydraulic actuator. The control circuitry 2 outputs the pump command current I corresponding to the actuator operation signal to the corresponding regulator 12 (i.e., the regulator 12 of the pump 11 that supplies the hydraulic oil to the hydraulic actuator corresponding to the operator that has been operated).

Returning to FIG. 1, two codes 5 (a first code 5A corresponding to the first pump 11A and a second code 5B corresponding to the second pump 11B) are displayed on the surface of the hydraulic pump equipment 1. In a case where the number of pumps 11 included in the hydraulic pump equipment 1 is one, the number of codes 5 displayed on the surface of the hydraulic pump equipment 1 is also one. Alternatively, one code 5 may store below-described characteristic data of the two pumps 11.

For the display of each code 5 on the surface of the hydraulic pump equipment 1, the code 5 may be printed on a plate, and the plate may be mounted to the hydraulic pump equipment 1. Alternatively, the code 5 may be directly printed on the surface of the hydraulic pump equipment 1.

The first code 5A stores characteristic data indicating actual I-q characteristics of the first pump 11A (the I-q characteristics are a relationship between the pump command current I and the displacement q). The second code 5B stores characteristic data indicating actual I-q characteristics of the second pump 11B. For example, the code 5 is a matrix two-dimensional code (QR code (registered trademark)). Alternatively, the first code 5A may store characteristic data indicating actual I-Q characteristics of the first pump 11A (the I-Q characteristics are a relationship between the pump command current I and a delivery flow rate Q) and indicating a predetermined pump rotation speed N. The same is true for the second code 5B.

The mobile terminal 4 includes a memory 41, a touchscreen 42, a camera 43, a wireless communicator 44, and a processor 45. These elements are connected to each other by a bus 46. The mobile terminal 4 is, for example, a tablet terminal or a smartphone.

The memory 41 includes, for example, main memories such as a RAM and ROM and a storage such as a hard disk or flash memory. The aforementioned program is stored in the memory 41. The touchscreen 42 functions as an inputter and an outputter. The processor 45 is, for example, a CPU.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The processor 45 of the mobile terminal 4 performs operations described below in accordance with the program stored in the memory 41.

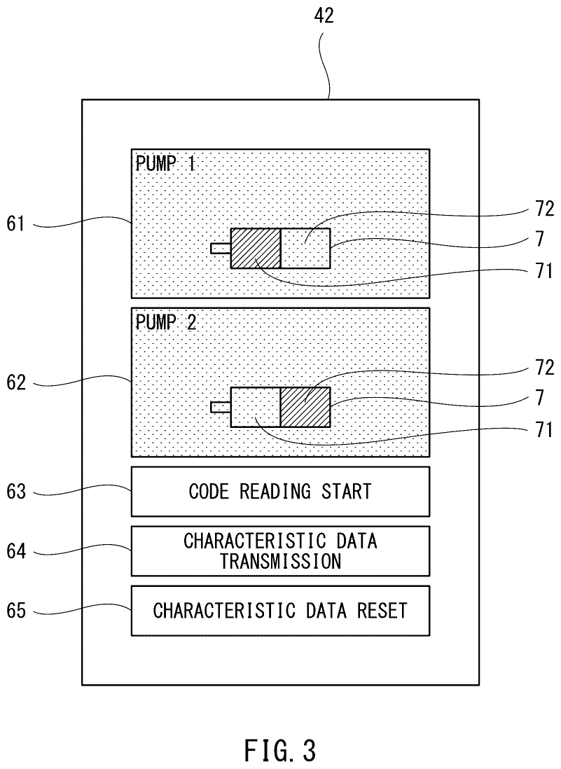

When a program icon that represents the program and that is displayed on the touchscreen 42 is tap-operated, the processor 45 displays a screen as shown in FIG. 3 on the touchscreen 42. Specifically, the processor 45 displays a first display frame 61 and a second display frame 62 on the touchscreen 42. The first display frame 61 is a frame to display information on the first pump 11A, and the second display frame 62 is a frame to display information on the second pump 11B. For example, the processor 45 displays “PUMP 1” in the first display frame 61, and displays “PUMP 2” in the second display frame 62.

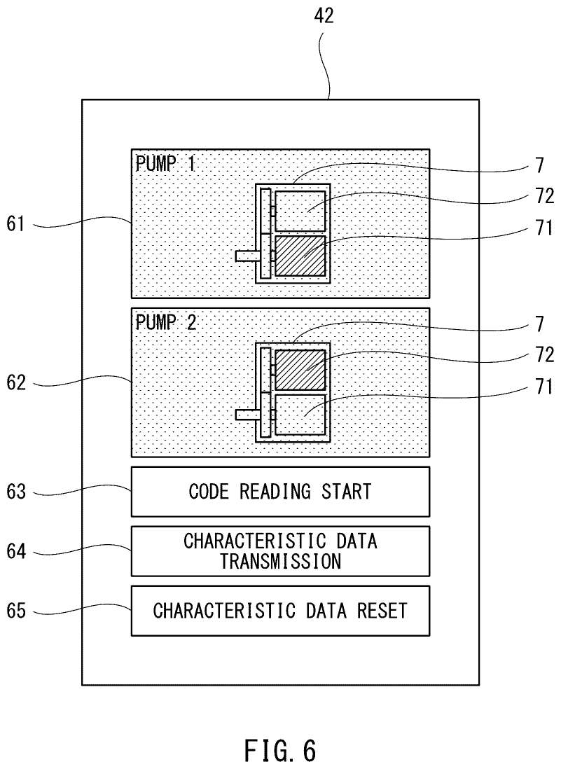

The processor 45 further displays a pump icon 7 in each of the first display frame 61 and the second display frame 62. The pump icon 7 represents the hydraulic pump equipment 1. The pump icon 7 includes: a first region 71, which indicates the position of the first pump 11A; and a second region 72, which indicates the position of the second pump 11B. Since the hydraulic pump equipment 1 of the present embodiment is of a tandem type as described above, the first region 71 and the second region 72 are located side by side in the axial direction of the input shaft. However, in a case where the hydraulic pump equipment 1 is of a parallel type, as shown in FIG. 6, the first region 71 and the second region 72 may be located side by side in a direction orthogonal to the axial direction of the input shaft.

As shown in FIG. 3 and FIG. 6, the processor 45 displays the pump icon 7 in the first display frame 61 in a manner to highlight the first region 71, and displays the pump icon 7 in the second display frame 62 in a manner to highlight the second region 72. The first region 71 and the second region 72 are displayed in a highlighted manner, for example, by being displayed in a color that stands out.

Returning to FIG. 3, the processor 45 further displays a code reading start button 63, a characteristic data transmission button 64, and a characteristic data reset button 65, which are virtual buttons, on the touchscreen 42.

The code reading start button 63 is a button to receive an input to start reading the first code 5A and the second code 5B displayed on the surface of the hydraulic pump equipment 1. When the code reading start button 63 is tap-operated by a user, the processor 45 starts the camera 43.

When the camera 43 focuses on the first code 5A or the second code 5B, the camera 43 automatically captures an image of the first code 5A or the second code 5B. When the camera 43 has captured an image of the first code 5A, the processor 45 obtains characteristic data of the first pump 11A, which is stored in the first code 5A, and stores the characteristic data in the memory 41. Similarly, when the camera 43 has captured an image of the second code 5B, the processor 45 obtains characteristic data of the second pump 11B, which is stored in the second code 5B, and stores the characteristic data in the memory 41. That is, reading the code 5 (the first code 5A or the second code 5B) means obtaining the characteristic data stored in the code 5 by capturing an image of the code 5.

Before the first code 5A and the second code 5B are read, the processor 45 displays the first display frame 61 and the second display frame 62 in, for example, grey to explicitly indicate that the first code 5A and the second code 5B have not been read yet.

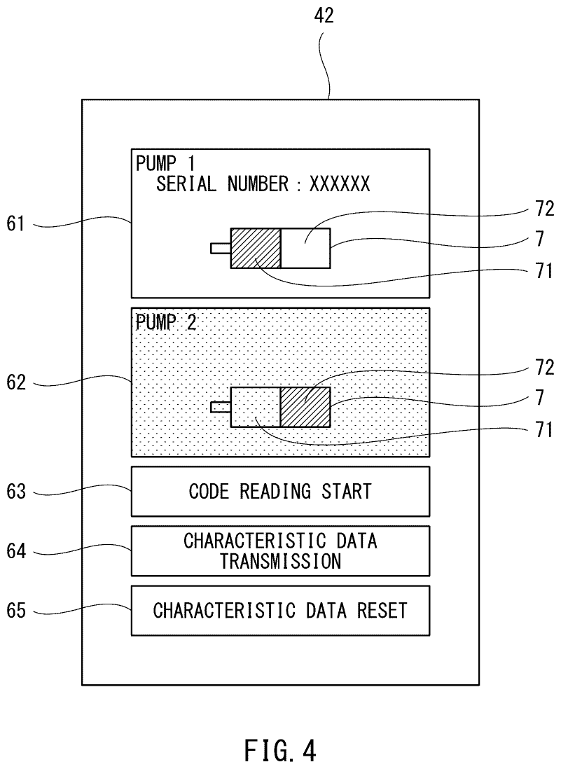

When the camera 43 has captured an image of the first code 5A, the processor 45 explicitly indicates that the first code 5A has been read by changing the color of the first display frame 61 as shown in FIG. 4. For example, the first code 5A further stores a serial number of the hydraulic pump equipment 1, and when the camera 43 has captured an image of the second code 5B, the processor 45 may display the serial number in the first display frame 61.

Similarly, when the camera 43 has captured an image of the second code 5B, the processor 45 explicitly indicates that the second code 5B has been read by changing the color of the second display frame 62.

As described above, by changing the color of the first display frame 61 or the second display frame 62, which one of the first code 5A or the second code 5B has been read can be indicated for the user of the mobile terminal 4, and also, the user can recognize which one of the codes needs to be read next.

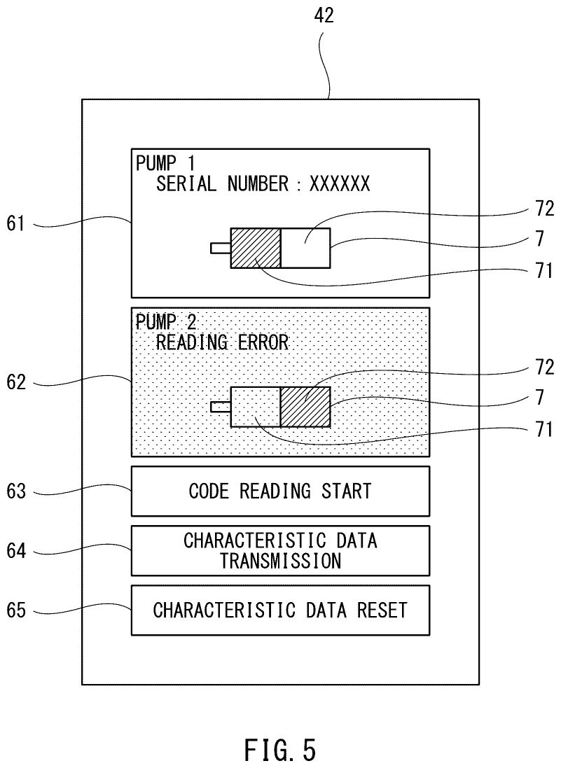

Further, when the camera 43 has captured an image of the first code 5A or the second code 5B two times consecutively, the processor 45 displays, on the touchscreen 42, that the reading performed for the second time is an error. For example, when the camera 43 has captured an image of the first code 5A two times consecutively, the processor 45 may display “READING ERROR” in the second display frame 62 (or in the first display frame 61) as shown in FIG. 5. In this manner, the user of the mobile terminal 4 can be informed that the reading performed for the second time is an error.

The aforementioned virtual characteristic data transmission button 64 is a button to receive an input to transmit characteristic data to the wireless LAN router 3. After the reading of the first code 5A and the second code 5B has been completed, when the characteristic data transmission button 64 is tap-operated, the processor 45 causes the wireless communicator 44 to transmit the characteristic data of the first pump 11A and the characteristic data of the second pump 11B, which are stored in the memory 41, to the wireless LAN router 3. Accordingly, the characteristic data of the first pump 11A and the characteristic data of the second pump 11B are inputted to the control circuitry 2 via the wireless LAN router 3.

The control circuitry 2 electronically calibrates variation in I-q characteristics of each of the first pump 11A and the second pump 11B due to their individual differences. Specifically, the control circuitry 2 uses the characteristic data inputted thereto to adjust the pump command current I outputted to the regulator 12, such that a preset displacement corresponding to the operating amount of the operator is obtained.

The virtual characteristic data reset button 65 is a button to receive an input to reset the characteristic data of the first pump 11A and the characteristic data of the second pump 11B that have been inputted to the control circuitry 2. When the characteristic data reset button 65 is tap-operated, the processor 45 causes the wireless communicator 44 to transmit a reset signal to reset the characteristic data to the wireless LAN router 3. Accordingly, the reset signal is inputted to the control circuitry 2 via the wireless LAN router 3.

Upon receiving the input of the reset signal, the control circuitry 2 determines the pump command current I by using an I-q characteristic map prestored in the control circuitry 2. As a result, the electronic calibration of variation in I-q characteristics due to individual differences is stopped. That is, the calibration by the control circuitry 2 can be stopped by operating the mobile terminal 4, specifically, by tap-operating the characteristic data reset button 65.

As described above, in the present embodiment, the code 5 (the first code 5A or the second code 5B) displayed on the surface of the hydraulic pump equipment 1 is read by the camera 43, and the characteristic data of the pump 11 (the first pump 11A or the second pump 11B), which is stored in the code 5, is transmitted from the mobile terminal 4 to the wireless LAN router 3 connected to the control circuitry 2. Thus, the characteristic data of the pump 11 can be inputted from the mobile terminal 4 to the control circuitry 2.

Moreover, in the present embodiment, the first display frame 61 and the second display frame 62 are displayed on the touchscreen 42. In this manner, the display screen of the touchscreen 42 can be made a display screen suitable for the hydraulic pump equipment 1 including the two pumps 11, which are the first pump 11A and the second pump 11B.

### VARIATIONS

The present disclosure is not limited to the above-described embodiment. Various modifications can be made without departing from the scope of the present disclosure.

For example, in a case where the control circuitry 2 includes a wireless communicator, when the characteristic data transmission button 64 is tap-operated, the processor 45 of the mobile terminal 4 causes the wireless communicator 44 to transmit the characteristic data of the first pump 11A and the characteristic data of the second pump 11B to the control circuitry 2. In this case, when the characteristic data reset button 65 is tap-operated, the processor 45 of the mobile terminal 4 causes the wireless communicator 44 to transmit the above-described reset signal to the control circuitry 2. The characteristic data reset button 65 can be eliminated.

In the above-described embodiment, the characteristic data of the first pump 11A is stored in the first code 5A, and the characteristic data of the second pump 11B is stored in the second code 5B. Alternatively, save location information on the characteristic data of the first pump 11A may be stored in the first code 5A, and save location information on the characteristic data of the second pump 11B may be stored in the second code 5B. The save location information is, for example, the IP (Internet Protocol) address of a server that is the save location, or the URL (Uniform Resource Locator) of a particular hierarchy level of the server. In this case, the first code 5A and the second code 5B may each be a character string.

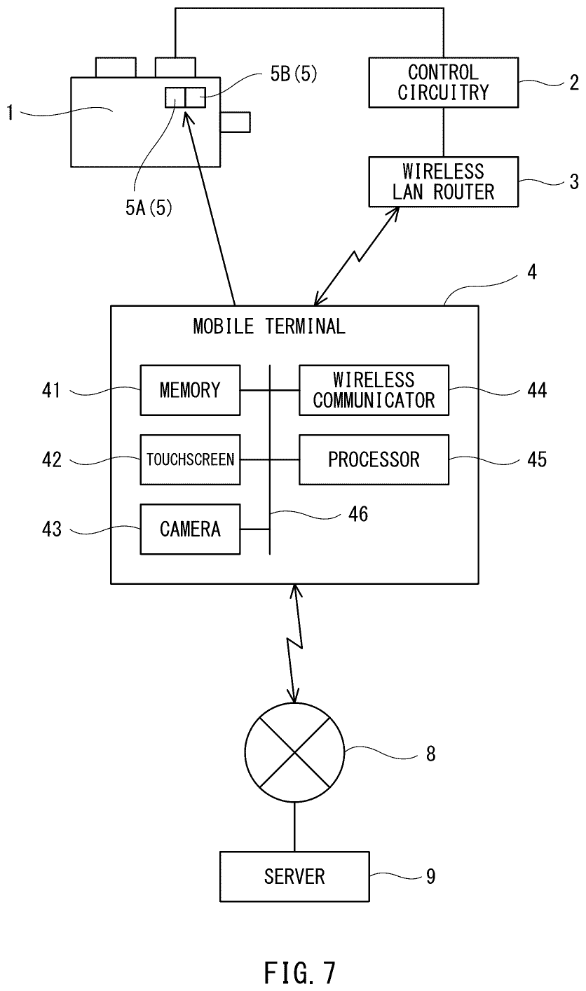

In the case where each of the first code 5A and the second code 5B stores save location information on the characteristic data, as shown in FIG. 7, when the camera 43 has captured an image of the first code 5A, the processor 45 of the mobile terminal 4 may obtain the characteristic data of the first pump 11A via a network 8 from a server 9 specified by the save location information stored in the first code 5A, and store the characteristic data in the memory 41. Similarly, when the camera 43 has captured an image of the second code 5B, the processor 45 may obtain the characteristic data of the second pump 11B via the network 8 from the server 9 specified by the save location information stored in the second code 5B, and store the characteristic data in the memory 41.

According to this configuration, the code 5 (the first code 5A or the second code 5B) displayed on the surface of the hydraulic pump equipment 1 is read by the camera 43, and the characteristic data of the pump 11 (the first pump 11A or the second pump 11B) is obtained from the server 9 specified by the save location information stored in the code 5. The obtained characteristic data is transmitted from the mobile terminal 4 to the wireless LAN router 3 connected to the control circuitry 2. Thus, the characteristic data of the pump 11 can be inputted from the mobile terminal 4 to the control circuitry 2.

Also in the case where each of the first code 5A and the second code 5B stores save location information on the characteristic data, the control circuitry 2 may include a wireless communicator, and the processor 45 of the mobile terminal 4 may cause the wireless communicator 44 to transmit the characteristic data of the first pump 11A and the characteristic data of the second pump 11B to the control circuitry 2.

The processor 45 of the mobile terminal 4 need not display the virtual code reading start button 63 on the touchscreen 42, and may start the camera 43 when the program icon displayed on the touchscreen 42 is tap-operated.

### SUMMARY

A first aspect of the present disclosure provides a mobile terminal including a processor, a memory, a wireless communicator, a touchscreen, and a camera. The processor: when the camera has captured an image of at least one code that is displayed on a surface of hydraulic pump equipment and that stores characteristic data of at least one pump included in the hydraulic pump equipment, stores the characteristic data in the memory; displays, on the touchscreen, a virtual characteristic data transmission button to receive an input to transmit the characteristic data to control circuitry for the hydraulic pump equipment or to a wireless LAN router connected to the control circuitry, and causes the wireless communicator to transmit the characteristic data stored in the memory to the control circuitry or to the wireless LAN router when the characteristic data transmission button is tap-operated.

According to the above configuration, the code displayed on the surface of the hydraulic pump equipment is read by the camera, and the characteristic data of the pump, which is stored in the code, is transmitted from the mobile terminal to the control circuitry or to the wireless LAN router connected to the control circuitry. Thus, the characteristic data of the pump can be inputted from the mobile terminal to the control circuitry.

A second aspect of the present disclosure provides a mobile terminal including a processor, a memory, a wireless communicator, a touchscreen, and a camera. The processor: when the camera has captured an image of at least one code displayed on a surface of hydraulic pump equipment, obtains characteristic data of at least one pump included in the hydraulic pump equipment via a network from a server specified by save location information stored in the at least one code, and stores the characteristic data in the memory; displays, on the touchscreen, a virtual characteristic data transmission button to receive an input to transmit the characteristic data to control circuitry for the hydraulic pump equipment or to a wireless LAN router connected to the control circuitry; and causes the wireless communicator to transmit the characteristic data stored in the memory to the control circuitry or to the wireless LAN router when the characteristic data transmission button is tap-operated.

According to the above configuration, the code displayed on the surface of the hydraulic pump equipment is read by the camera, and the characteristic data of the pump is obtained from the server specified by the save location information stored in the code. The obtained characteristic data is transmitted from the mobile terminal to the control circuitry or to the wireless LAN router connected to the control circuitry. Thus, the characteristic data of the pump can be inputted from the mobile terminal to the control circuitry.

For example, the processor may: display, on the touchscreen, a virtual code reading start button to receive an input to start reading the at least one code; and start the camera when the code reading start button is tap-operated. Alternatively, the processor may start the camera when a program icon that is displayed on the touchscreen and that represents a program installed on the mobile terminal is tap-operated.

The at least one pump may include a first pump and a second pump. The at least one code may include a first code that stores the characteristic data of the first pump and a second code that stores the characteristic data of the second pump. The processor may: display, on the touchscreen, a first display frame to display information on the first pump and a second display frame to display information on the second pump; display a pump icon in each of the first display frame and the second display frame, the pump icon representing the hydraulic pump equipment and including a first region and a second region, the first region indicating a position of the first pump, the second region indicating a position of the second pump; display the pump icon in the first display frame in a manner to highlight the first region; and display the pump icon in the second display frame in a manner to highlight the second region. According to this configuration, the display screen of the touchscreen can be made a display screen suitable for the hydraulic pump equipment including the two pumps, which are the first pump and the second pump.

The processor may: when the camera has captured an image of the first code, store the characteristic data of the first pump in the memory, and change a color of the first display frame; and when the camera has captured an image of the second code, store the characteristic data of the second pump in the memory, and change a color of the second display frame. According to this configuration, which one of the first code or the second code has been read can be indicated for the user of the mobile terminal, and also, the user can recognize which one of the codes needs to be read next.

When the camera has captured an image of the first code or the second code two times consecutively, the processor may display, on the touchscreen, that reading performed for the second time is an error. According to this configuration, the user of the mobile terminal can be informed that the reading performed for the second time is an error.

The processor may: display, on the touchscreen, a virtual characteristic data reset button to receive an input to reset the characteristic data that has been transmitted to the control circuitry or to the wireless LAN router; and cause the wireless communicator to transmit a signal to reset the characteristic data to the control circuitry or to the wireless LAN router when the characteristic data reset button is tap-operated. According to this configuration, calibration by the control circuitry can be stopped by operating the mobile terminal.

A third aspect of the present disclosure provides a program for a mobile terminal, the mobile terminal including a processor, a memory, a wireless communicator, a touchscreen, and a camera. The program causes the processor to: when the camera has captured an image of at least one code that is displayed on a surface of hydraulic pump equipment and that stores characteristic data of at least one pump included in the hydraulic pump equipment, store the characteristic data in the memory; display, on the touchscreen, a virtual characteristic data transmission button to receive an input to transmit the characteristic data to control circuitry for the hydraulic pump equipment or to a wireless LAN router connected to the control circuitry; and cause the wireless communicator to transmit the characteristic data stored in the memory to the control circuitry or to the wireless LAN router when the characteristic data transmission button is tap-operated.

According to the above configuration, the code displayed on the surface of the hydraulic pump equipment is read by the camera, and the characteristic data of the pump, which is stored in the code, is transmitted from the mobile terminal to the control circuitry or to the wireless LAN router connected to the control circuitry. Thus, the characteristic data of the pump can be inputted from the mobile terminal to the control circuitry.

A fourth aspect of the present disclosure provides a program for a mobile terminal, the mobile terminal including a processor, a memory, a wireless communicator, a touchscreen, and a camera. The program causes the processor to: when the camera has captured an image of at least one code displayed on a surface of hydraulic pump equipment, obtain characteristic data of at least one pump included in the hydraulic pump equipment via a network from a server specified by save location information stored in the at least one code, and store the characteristic data in the memory; display, on the touchscreen, a virtual characteristic data transmission button to receive an input to transmit the characteristic data to control circuitry for the hydraulic pump equipment or to a wireless LAN router connected to the control circuitry; and cause the wireless communicator to transmit the characteristic data stored in the memory to the control circuitry or to the wireless LAN router when the characteristic data transmission button is tap-operated.

According to the above configuration, the code displayed on the surface of the hydraulic pump equipment is read by the camera, and the characteristic data of the pump is obtained from the server specified by the save location information stored in the code. The obtained characteristic data is transmitted from the mobile terminal to the control circuitry or to the wireless LAN router connected to the control circuitry. Thus, the characteristic data of the pump can be inputted from the mobile terminal to the control circuitry.

For example, the above program may cause the processor to: display, on the touchscreen, a virtual code reading start button to receive an input to start reading the at least one code; and start the camera when the code reading start button is tap-operated. Alternatively, the above program may cause the processor to start the camera when a program icon that is displayed on the touchscreen and that represents the program is tap-operated.

The at least one pump may include a first pump and a second pump. The at least one code may include a first code that stores the characteristic data of the first pump and a second code that stores the characteristic data of the second pump. The above program may cause the processor to: display, on the touchscreen, a first display frame to display information on the first pump and a second display frame to display information on the second pump; display a pump icon in each of the first display frame and the second display frame, the pump icon representing the hydraulic pump equipment and including a first region and a second region, the first region indicating a position of the first pump, the second region indicating a position of the second pump; display the pump icon in the first display frame in a manner to highlight the first region; and display the pump icon in the second display frame in a manner to highlight the second region. According to this configuration, the display screen of the touchscreen can be made a display screen suitable for the hydraulic pump equipment including the two pumps, which are the first pump and the second pump.

The above program may cause the processor to: when the camera has captured an image of the first code, store the characteristic data of the first pump in the memory, and change a color of the first display frame; and when the camera has captured an image of the second code, store the characteristic data of the second pump in the memory, and change a color of the second display frame. According to this configuration, which one of the first code or the second code has been read can be indicated for the user of the mobile terminal, and also, the user can recognize which one of the codes needs to be read next.

When the camera has captured an image of the first code or the second code two times consecutively, the above program may cause the processor to display, on the touchscreen, that reading performed for the second time is an error. According to this configuration, the user of the mobile terminal can be informed that the reading performed for the second time is an error.

The above program may cause the processor to: display, on the touchscreen, a virtual characteristic data reset button to receive an input to reset the characteristic data that has been transmitted to the control circuitry or to the wireless LAN router; and cause the wireless communicator to transmit a signal to reset the characteristic data to the control circuitry or to the wireless LAN router when the characteristic data reset button is tap-operated. According to this configuration, calibration by the control circuitry can be stopped by operating the mobile terminal.

A fifth aspect of the present disclosure provides a method of processing characteristic data of a hydraulic pump by using a mobile terminal, the method including: when a camera of the mobile terminal has captured an image of at least one code that is displayed on a surface of hydraulic pump equipment and that stores characteristic data of at least one pump included in the hydraulic pump equipment, storing the characteristic data in a memory of the mobile terminal; displaying, on a touchscreen of the mobile terminal, a virtual characteristic data transmission button to receive an input to transmit the characteristic data to control circuitry for the hydraulic pump equipment or to a wireless LAN router connected to the control circuitry; and causing a wireless communicator of the mobile terminal to transmit the characteristic data stored in the memory to the control circuitry or to the wireless LAN router when the characteristic data transmission button is tap-operated.

According to the above configuration, the code displayed on the surface of the hydraulic pump equipment is read by the camera, and the characteristic data of the pump, which is stored in the code, is transmitted from the mobile terminal to the control circuitry or to the wireless LAN router connected to the control circuitry. Thus, the characteristic data of the pump can be inputted from the mobile terminal to the control circuitry.

A sixth aspect of the present disclosure provides a method of processing characteristic data of a hydraulic pump by using a mobile terminal, the method including: when a camera of the mobile terminal has captured an image of at least one code displayed on a surface of hydraulic pump equipment, obtaining characteristic data of at least one pump included in the hydraulic pump equipment via a network from a server specified by save location information stored in the at least one code, and storing the characteristic data in a memory of the mobile terminal; displaying, on a touchscreen of the mobile terminal, a virtual characteristic data transmission button to receive an input to transmit the characteristic data to control circuitry for the hydraulic pump equipment or to a wireless LAN router connected to the control circuitry; and causing a wireless communicator of the mobile terminal to transmit the characteristic data stored in the memory to the control circuitry or to the wireless LAN router when the characteristic data transmission button is tap-operated.

According to the above configuration, the code displayed on the surface of the hydraulic pump equipment is read by the camera, and the characteristic data of the pump is obtained from the server specified by the save location information stored in the code. The obtained characteristic data is transmitted from the mobile terminal to the control circuitry or to the wireless LAN router connected to the control circuitry. Thus, the characteristic data of the pump can be inputted from the mobile terminal to the control circuitry.

For example, the method may include: displaying, on the touchscreen, a virtual code reading start button to receive an input to start reading the at least one code; and starting the camera when the code reading start button is tap-operated. Alternatively, the method may include: starting the camera when a program icon that is displayed on the touchscreen and that represents a program installed on the mobile terminal is tap-operated.

The at least one pump may include a first pump and a second pump. The at least one code may include a first code that stores the characteristic data of the first pump and a second code that stores the characteristic data of the second pump. The method may include: displaying, on the touchscreen, a first display frame to display information on the first pump and a second display frame to display information on the second pump; displaying a pump icon in each of the first display frame and the second display frame, the pump icon representing the hydraulic pump equipment and including a first region and a second region, the first region indicating a position of the first pump, the second region indicating a position of the second pump; displaying the pump icon in the first display frame in a manner to highlight the first region; and displaying the pump icon in the second display frame in a manner to highlight the second region. According to this configuration, the display screen of the touchscreen can be made a display screen suitable for the hydraulic pump equipment including the two pumps, which are the first pump and the second pump.

The method may include: when the camera has captured an image of the first code, storing the characteristic data of the first pump in the memory, and changing a color of the first display frame; and when the camera has captured an image of the second code, storing the characteristic data of the second pump in the memory, and changing a color of the second display frame. According to this configuration, which one of the first code or the second code has been read can be indicated for the user of the mobile terminal, and also, the user can recognize which one of the codes needs to be read next.

The method may include: when the camera has captured an image of the first code or the second code two times consecutively, displaying, on the touchscreen, that reading performed for the second time is an error. According to this configuration, the user of the mobile terminal can be informed that the reading performed for the second time is an error.

The method may include: displaying, on the touchscreen, a virtual characteristic data reset button to receive an input to reset the characteristic data that has been transmitted to the control circuitry or to the wireless LAN router; and causing the wireless communicator to transmit a signal to reset the characteristic data to the control circuitry or to the wireless LAN router when the characteristic data reset button is tap-operated. According to this configuration, calibration by the control circuitry can be stopped by operating the mobile terminal.

1-24. (canceled)

25. A mobile terminal comprising a processor, a memory, a wireless communicator, a touchscreen, and a camera, wherein
the processor:
when the camera has captured an image of at least one code that is displayed on a surface of hydraulic pump equipment and that stores characteristic data of at least one pump included in the hydraulic pump equipment, stores the characteristic data in the memory;
displays, on the touchscreen, a virtual characteristic data transmission button to receive an input to transmit the characteristic data to control circuitry for the hydraulic pump equipment or to a wireless LAN router connected to the control circuitry, and
causes the wireless communicator to transmit the characteristic data stored in the memory to the control circuitry or to the wireless LAN router when the characteristic data transmission button is tap-operated.

26. A mobile terminal comprising a processor, a memory, a wireless communicator, a touchscreen, and a camera, wherein
the processor:
when the camera has captured an image of at least one code displayed on a surface of hydraulic pump equipment, obtains characteristic data of at least one pump included in the hydraulic pump equipment via a network from a server specified by save location information stored in the at least one code, and stores the characteristic data in the memory;
displays, on the touchscreen, a virtual characteristic data transmission button to receive an input to transmit the characteristic data to control circuitry for the hydraulic pump equipment or to a wireless LAN router connected to the control circuitry; and
causes the wireless communicator to transmit the characteristic data stored in the memory to the control circuitry or to the wireless LAN router when the characteristic data transmission button is tap-operated.

27. The mobile terminal according to claim 25, wherein
the processor:
displays, on the touchscreen, a virtual code reading start button to receive an input to start reading the at least one code; and
starts the camera when the code reading start button is tap-operated.

28. The mobile terminal according to claim 25, wherein
the processor starts the camera when a program icon that is displayed on the touchscreen and that represents a program installed on the mobile terminal is tap-operated.

29. The mobile terminal according to claim 25, wherein
the at least one pump includes a first pump and a second pump,
the at least one code includes a first code that stores the characteristic data of the first pump and a second code that stores the characteristic data of the second pump, and
the processor:
displays, on the touchscreen, a first display frame to display information on the first pump and a second display frame to display information on the second pump;
displays a pump icon in each of the first display frame and the second display frame, the pump icon representing the hydraulic pump equipment and including a first region and a second region, the first region indicating a position of the first pump, the second region indicating a position of the second pump;
displays the pump icon in the first display frame in a manner to highlight the first region; and
displays the pump icon in the second display frame in a manner to highlight the second region.

30. The mobile terminal according to claim 29, wherein
the processor:
when the camera has captured an image of the first code, stores the characteristic data of the first pump in the memory, and changes a color of the first display frame; and
when the camera has captured an image of the second code, stores the characteristic data of the second pump in the memory, and changes a color of the second display frame.

31. The mobile terminal according to claim 29, wherein
when the camera has captured an image of the first code or the second code two times consecutively, the processor displays, on the touchscreen, that reading performed for the second time is an error.

32. The mobile terminal according to claim 25, wherein
the processor:
displays, on the touchscreen, a virtual characteristic data reset button to receive an input to reset the characteristic data that has been transmitted to the control circuitry or to the wireless LAN router; and
causes the wireless communicator to transmit a signal to reset the characteristic data to the control circuitry or to the wireless LAN router when the characteristic data reset button is tap-operated.

33. The mobile terminal according to claim 26, wherein
the processor:
displays, on the touchscreen, a virtual code reading start button to receive an input to start reading the at least one code; and
starts the camera when the code reading start button is tap-operated.

34. The mobile terminal according to claim 26, wherein
the processor starts the camera when a program icon that is displayed on the touchscreen and that represents a program installed on the mobile terminal is tap-operated.

35. The mobile terminal according to claim 26, wherein
the at least one pump includes a first pump and a second pump,
the at least one code includes a first code that stores the characteristic data of the first pump and a second code that stores the characteristic data of the second pump, and
the processor:
displays, on the touchscreen, a first display frame to display information on the first pump and a second display frame to display information on the second pump;
displays a pump icon in each of the first display frame and the second display frame, the pump icon representing the hydraulic pump equipment and including a first region and a second region, the first region indicating a position of the first pump, the second region indicating a position of the second pump;
displays the pump icon in the first display frame in a manner to highlight the first region; and
displays the pump icon in the second display frame in a manner to highlight the second region.

36. The mobile terminal according to claim 35, wherein
the processor:
when the camera has captured an image of the first code, stores the characteristic data of the first pump in the memory, and changes a color of the first display frame; and
when the camera has captured an image of the second code, stores the characteristic data of the second pump in the memory, and changes a color of the second display frame.

37. The mobile terminal according to claim 35, wherein
when the camera has captured an image of the first code or the second code two times consecutively, the processor displays, on the touchscreen, that reading performed for the second time is an error.

38. The mobile terminal according to claim 26, wherein
the processor:
displays, on the touchscreen, a virtual characteristic data reset button to receive an input to reset the characteristic data that has been transmitted to the control circuitry or to the wireless LAN router; and
causes the wireless communicator to transmit a signal to reset the characteristic data to the control circuitry or to the wireless LAN router when the characteristic data reset button is tap-operated.
